(19) United States
(12) Patent Application Publication
(10) Pub. No.: US 2012/0167925 A1
(43) Pub. Date: Jul. 5, 2012

(54) Compressor Cleaner

(75) Inventors: Chi-Hung Lo, Lujhu Township (TW); Mau-Jia Chen, Lujhu Township (TW)

(73) Assignee: HENG SHENG PRECISION TECH CO., LTD., Lujhu Township (TW)

(21) Appl. No.: 12/984,840

(22) Filed: Jan. 5, 2011

(51) Int. Cl. B08B 3/00

(52) U.S. Cl. 134/70

(57) ABSTRACT

A compressor cleaner includes a machine body with a tunnel, a transporting unit connected with several conveyors, a driving unit for driving the compressors on the conveyors to rotate dining the cycle. The conveyors are driven by the transporting unit to enter an entry side and to carry compressors. They first enter the cleaning room for cleaning, then the front drying room and the rear drying room for drying. The dried compressor then goes to the exit side.

### BACKGROUND OF THE INVENTION

1. Field of Invention

The invention relates to a compressor cleaner and, in particular, to a device that follows an automated procedure to clean a compressor.

2. Related Art

After a compressor is assembled, it has to pass a pressure test in order to finish the assembly procedure. After that, the compressor body is always left with oil and stains. In particular, the rough areas or places with significant height changes on the surface of the body are most difficult to clean.

When cleaning the compressor, the body has to be dried after rinsing. In the prior art, the compressor is cleaned and dried manually, it is therefore very time-consuming. In order to maintain the cleaning speed, more manpower is required. This thus has a higher manpower cost. Therefore, how to increase the efficiency of cleaning compressors is an important issue.

### SUMMARY OF THE INVENTION

An objective of the invention is to solve the above-mentioned problem by providing a compressor cleaner. The compressor can be cleaned following an automated procedure in order to increase the cleaning efficiency. This also saves the cost for manual cleaning.

To achieve the above-mentioned objective, the invention includes:

a machine body with a horizontal tunnel;
a transporting unit disposed in the machine body and at the bottom of the tunnel, combined with several conveyors for supporting the compressor, and running vertically and cyclically in a stripe, each of the conveyors being standing and running with the transporting unit, and each of the conveyors exposing on the machine body when rising to the top; and
a driving unit disposed in the machine body in order to let the compressor on each of the conveyors to rotate during the cycle.

Each conveyor is driven by the transporting unit to go through a compressor entry side, a cleaning room for cleaning the compressor, a front drying room that blows a cold wind to dry the compressor, a rear drying room that blows a hot wind to dry the compressor, and a compressor exit side. The entry side the and exit side are at the front end and the rear end of the tunnel, respectively. The cleaning room, the front drying room, and the rear drying room are all in the tunnel.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a planar view of the disclosed cleaner;

FIG. 2 is a side view of the conveyor according to the invention;

FIG. 3 is another side view of the conveyor according to the invention;

FIG. 4 is a schematic view of rinsing in the cleaning room;

FIG. 5 is a schematic view of cold drying in the front drying room;

FIG. 6 is a schematic view of hot drying in the rear drying room;

FIG. 7 is a cross-sectional view of the air hide pipe in the front/rear drying rooms;

FIG. 8 is a schematic view showing how the driving unit works;

FIG. 9 is a schematic view of the sensor; and

FIG. 10 is a schematic view of how the compressor is cleaned according to the invention.

### DETAILED DESCRIPTION OF THE INVENTION

The present invention will be apparent from the following detailed description, which proceeds with reference to the accompanying drawings, wherein the same references relate to the same elements.

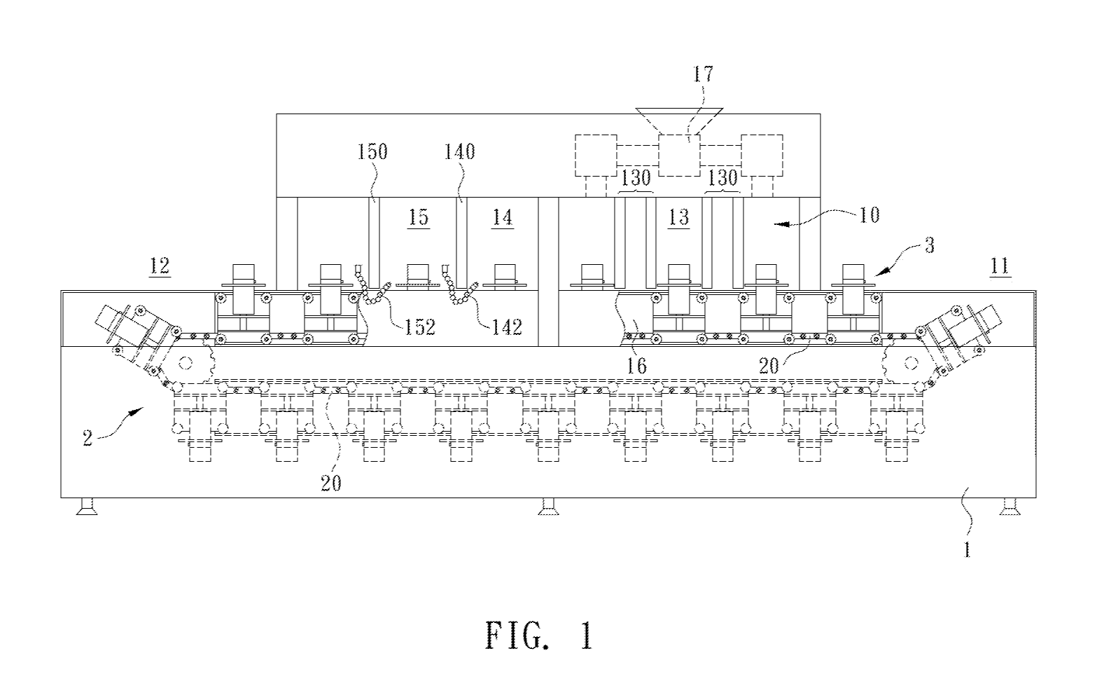

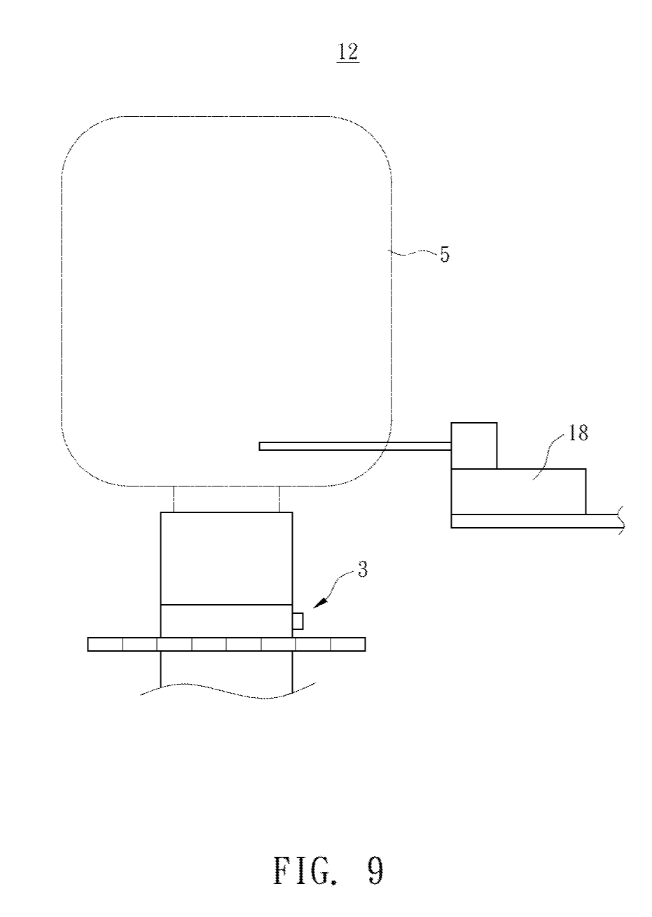

Please refer to FIGS. 1 to 10. The disclosed compressor cleaner includes a machine body 1, a transporting unit 2, several conveyors 3, and a driving unit 4 for cleaning a compressor 5.

As shown in FIG. 1, the machine body 1 in this embodiment is a horizontal structure. The machine body 1 has a horizontal tunnel 10. The front end of the tunnel 10 is an entry side 11. The rear end of the tunnel 10 is an exit side 12. From the entry side 11 t the exit side 12, the runnel 10 has in sequence a cleaning room 13, a front drying room 14, and a rear drying room 15. The compressor 5 to be cleaned is manually disposed on one of the several conveyors 3 from the entry side 11. The compressor 5 runs to the cleaning room 13 for cleaning. It is then cold dried in the front drying room 14. Afterwards, it is hot dried in the rear drying room 15. When the compressor 5 runs to the exit side 12, it is manually taken out.

As shown in FIG. 1, the transporting unit 2 in this embodiment includes a transporting chain 20. The machine body 1 has a track 16. The transporting chain 20 runs along the track 16. Several conveyors 3 are connected to the transporting chain 20, with a fixed distance in between. Each of the conveyors is driven by the transporting chain 20 to run cyclically in stripe. (The transporting unit 2 in this embodiment winds the transporting chain 20 around a dial. A driving motor drives the dial to rotate the transporting chain 20. This is not shown in the drawing.)

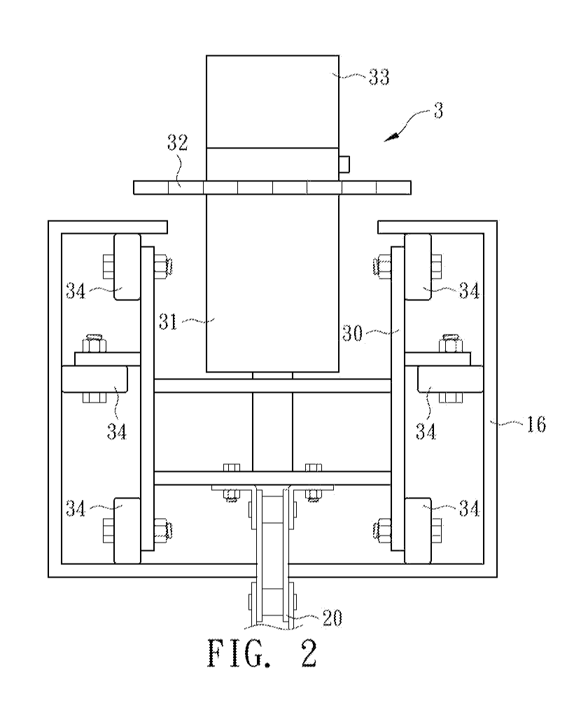

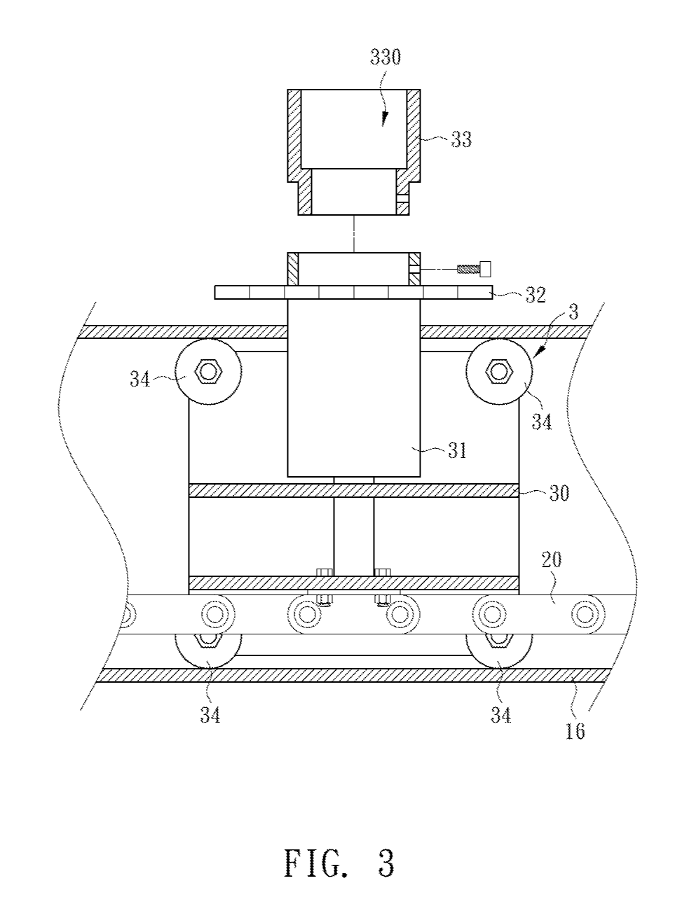

Please refer to FIGS. 2 to 3. Each of the conveyors 3 includes a support 30. The support 30 is connected with the transporting chain 20 in the track 16. The conveyor 3 has a supporting base 31 pivotally fixed on the support 30 and exposed from the track 16. The supporting base 31 is surrounded by a saw disk 32. The saw disk 32 is horizontal relative to the supporting base 31. A tool 33 is disposed above the saw disk 32, and can be replaced on the supporting base 31. The tool 33 is recessed with a positioning hole 330. The positioning hole 330 allows the insertion of the front end of the compressor 5.

As shown in FIGS. 2 and 3, the support 30 in this embodiment has several rollers 34 around it. The top and bottom ends on both sides of the support 30 have a roller 34, respectively. The central positions on both sides also have a roller 34, respectively. The rollers 34 urge against the inner side of the track 16. Using these rollers 34, the support 30 is guided and corrected while running along the track 16.

When the conveyors 3 are driven by the transporting unit 2 to the entry side 11, the front end of the compressor 5 is manually inserted into the positioning hole 330 of the tool 33. In this case, the compressor 5 runs with the transporting unit 2 into the tunnel 10 of the cleaning room 13. If the size of the front end of the compressor 5 is different, one can replace the tool 33 by one with an appropriate positioning hole 330.

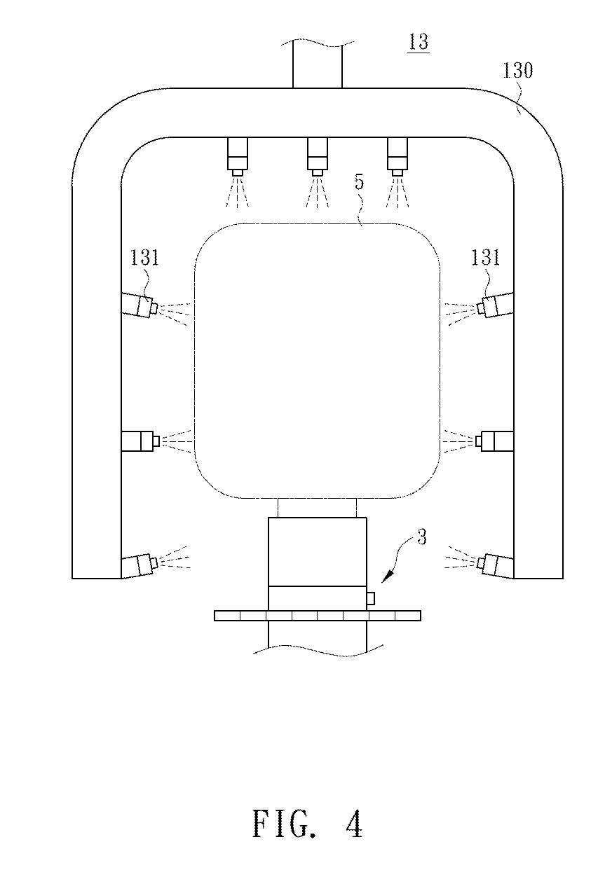

As shown in FIG. 4, the cleaning room 13 in this embodiment has two standing pipes 130 at the front and rear ends, respectively. The two standing pipes 130 connect to a pump (not shown) with a high-pressure water source. The standing pipes 130 have several nozzles 131 on both sides of the tunnel 10. When compressors 5 pass by, the nozzles 131 spray and rinse the compressors 5.

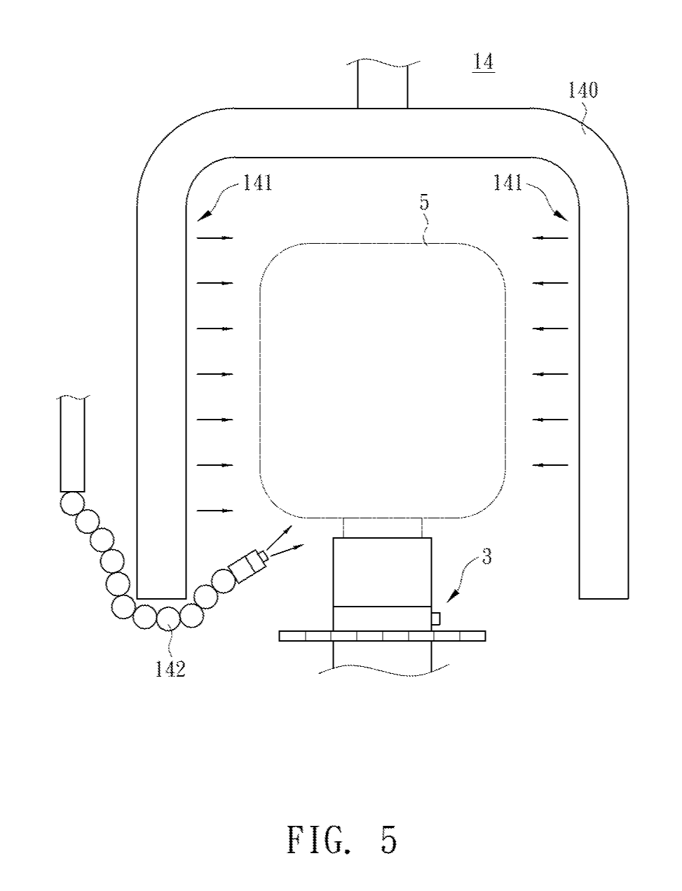

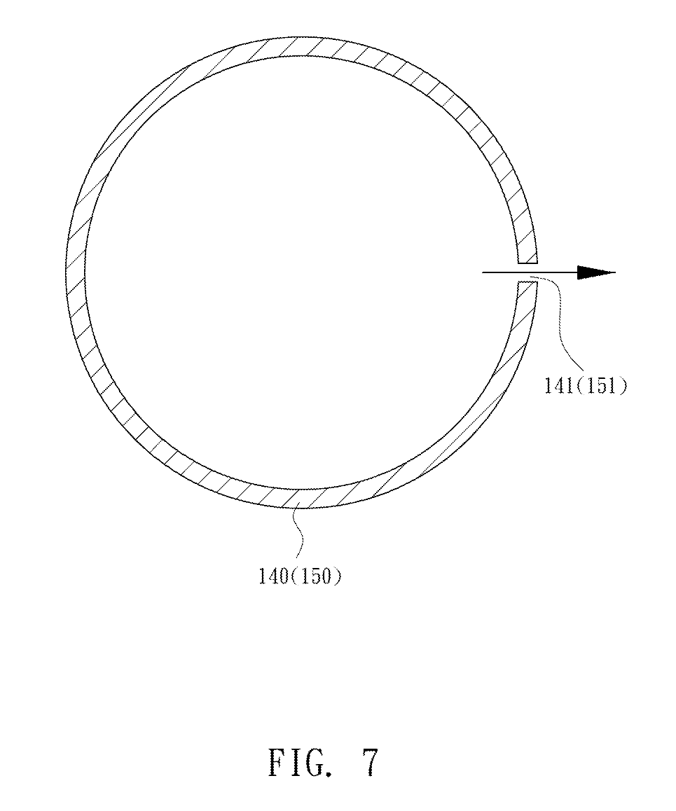

As shown in FIG. 5, the front drying room 14 in the tunnel has an air knife tube 10 connected to an air blower (not shown) with a high-pressure air source. The inner side of the air knife tube 140 on both sides of the tunnel 10 has an air knife opening 141, respectively (FIG. 7). The air knife opening 141 blows a high-pressure cold air toward the compressor 5. The front drying room 14 further has a universal nozzle 142 that blows a high-pressure air. The universal nozzle 142 can adjust its blowing position on the compressor 5 in order to properly dry the compressor 5. When the compressor 5 goes through the cleaning room 13 and gets rinsed by the high-pressure water source, the cold air from the air knife opening 141 and the universal nozzle 142 of the front drying room 14 blow the water away. This provides preliminary drying to the compressor 5.

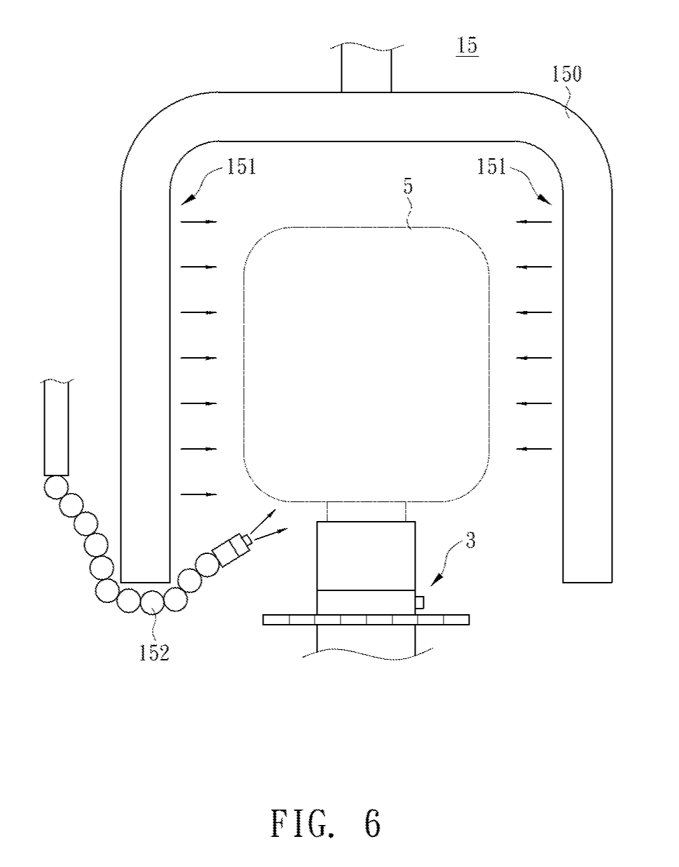

As shown in FIG. 6, the rear drying room 15 in this embodiment has an air knife tube 150 connected to an air blower (not shown) with a high-pressure air source. The high-pressure air source is equipped with a heater (not shown) to provide a hot air. The inner side of the air knife tube 15 on both sides of the tunnel 10 has an air knife opening 151, respectively (FIG. 7). The air knife opening 151 blows a hot high-pressure air toward the compressor 5. The rear drying room 15 has at least one universal nozzle 152 that blows a high-pressure air. The universal nozzle 152 can adjust its blowing position on the compressor 5 in order to properly dry the compressor 5. After the compressor 5 goes through the front drying room 14 and gets dried by the high-pressure cold air. it is further dried by the hot air from the air knife opening 151 of the rear drying room 15. The universal nozzle 152 also helps drying. This completes the drying process for the compressor 5.

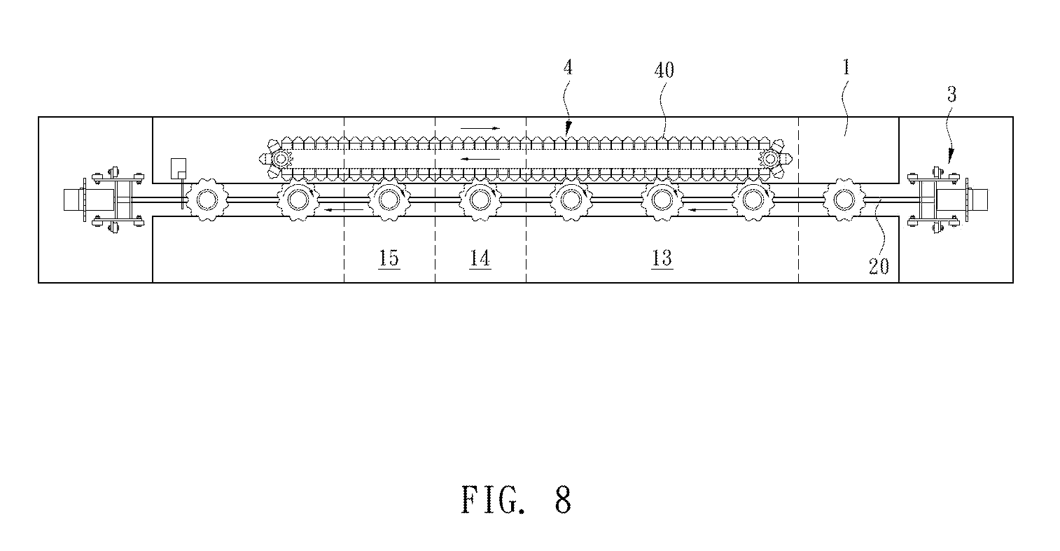

As shown in FIG. 8, the driving unit 4 includes several chain blocks 40. The chain blocks 40 run horizontally and cyclically in stripe. The driving unit 4 engages the saw disk 32 by its chain blocks 40. The compressor 5 is driven to rotate with the conveyor 31. When the compressors 5 on the conveyors 3 run in the tunnel 10 with the transporting unit 2, each of the compressors 5 rotates under the driving force of the driving unit 4. Therefore, each of the compressors 5 can rotate during the cleaning, front drying, and rear drying processes. Each part of the compressor 5 can thus be uniformly cleaned and dried.

As shown in FIG. 1, the machine body 1 in this embodiment has an exhaust fan 17 above the cleaning room 13. The exhaust fan 17 draws away the floating moisture in the tunnel during cleaning. Since the compressors on the conveyors 3 cannot go below the machine body 1 as the conveyors 3 move with the transporting unit 2, a sensor 18 is provided on the exit side 13 of the machine body 1. The sensor 18 detects whether any down-going conveyor 3 has a compressor 5 thereon. It prevents the compressor 5 from hitting the machine body 1 because it is not taken off on the exit side 12.

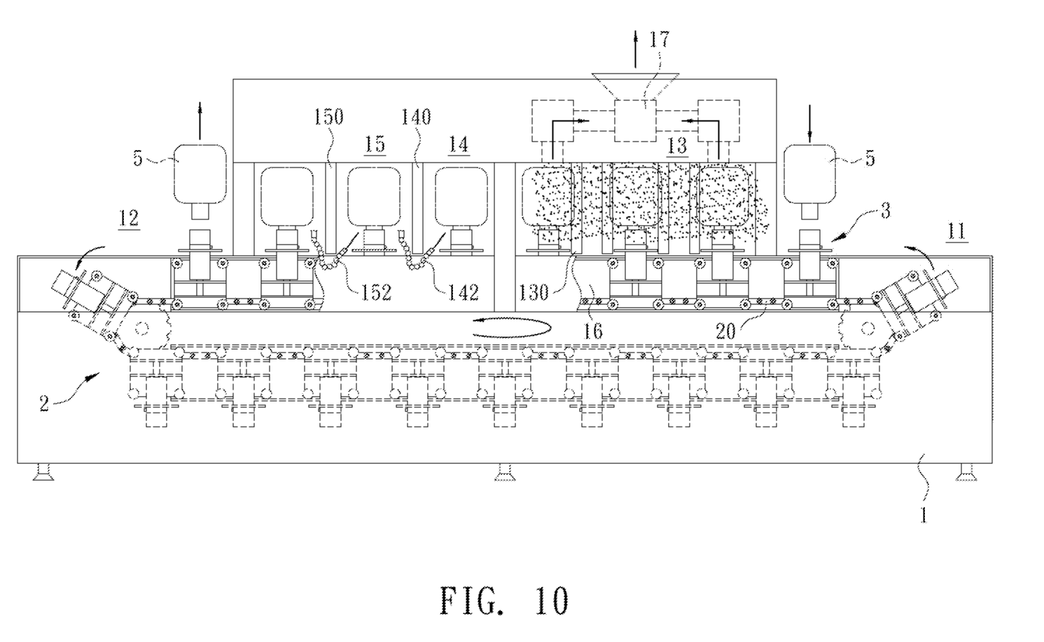

According to the above-mentioned structure, the disclosed compressor cleaner cleans the compressors 5 as follows. As shown in FIG. 10, the compressors 5 are manually disposed on the conveyors 3 on the entry side 11. Through the transmission of the transporting unit 2, the compressors 5 go into the cleaning room 13 of the tunnel 10. The nozzles 131 on the standing pipes 130 eject high-pressure water to rinse the self-rotating compressors 5. After rinsing, the compressors 5 enter the front drying room 14. The air knife opening 141 of the air knife tube 140 and the universal nozzle 142 provide preliminary drying. The compressors 5 then enter the rear drying room 15. The air knife opening 151 of the air knife tube 150 and the universal nozzle 152 provide complete drying for the compressors 5. After exiting via the exit side 12 of the tunnel 10, the compressors 5 are manually taken off. This completes the automated cleaning task of the compressors 5.

After a compressor 5 is assembled, it can be automatically cleaned using the disclosed compressor cleaner. The compressors 5 do not need to be cleaned manually and individually. In addition to better cleaning efficiency from automated machine cleaning, the invention saves costs in manpower.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A compressor cleaner, comprising:
a machine body having a horizontal tunnel;
a transporting unit disposed in the machine body and at the bottom of the tunnel, combined with several conveyors for supporting the compressor, and running vertically and cyclically in a stripe, each of the conveyors being standing and running with the transporting unit, and each of the conveyors exposing on the machine body when rising to the top; and
a driving unit disposed in the machine body in order to let the compressor on each of the conveyors to rotate during the cycle;
wherein each conveyor is driven by the transporting unit to go through a compressor entry side, a cleaning room for cleaning the compressor, a front drying room that blows a cold wind to dry the compressor, a rear drying room that blows a hot wind to dry the compressor, and a compressor exit side; the entry side the and exit side are at the front end and the rear end of the tunnel, respectively; and the cleaning room, the front drying room, and the rear drying room are all in the tunnel.

2. The compressor cleaner of claim 1, wherein the transporting unit includes a transporting chain, the machine body has a track for the transporting chain to run along, the conveyors are connected to the transporting chain with a fixed distance in between, each of the conveyors is driven by the transporting chain to cyclically run in stripe, the conveyor contains a support to connect with the transporting chain in the track, the support is pivotally connected with a supporting base exposed from the track, the supporting base is surrounded with a horizontal saw disk, the driving unit contains a plurality of chain blocks that run horizontally and cyclically in stripe, the driving unit engages with the saw disk by the chain blocks in order to drive the compressor into self rotations with the supporting base, the supporting base has a replaceable tool above the saw disk, and the tool is recessed with a positioning hole for the insertion of the front end of the compressor.

3. The compressor cleaner of claim 2, wherein the support has a plurality of rollers for guiding and correcting the support in the track, the rollers urging against the inner side of the track.

4. The compressor cleaner of claim 1 or 2, wherein the cleaning room has at least one standing pipe connected to a pump with a high-pressure water source, and each of the standing pipes has several nozzles on both sides of the tunnel toward the compressor for rinsing.

5. The compressor cleaner of claim 4, wherein the front drying room has at least one air knife tube connected with an air blower with a high-pressure air source, the air hide tube has on both sides of the tunnel an air knife opening blowing a high-pressure cold air toward the compressor, the front drying room also has an adjustable universal nozzle for blowing a high-pressure air toward a position on the compressor.

6. The compressor cleaner of claim 5, wherein the rear drying room has at least one air knife tube connected with an air blower with a high-pressure air source, the high-pressure air source is heated by a heater to produce a hot air, the air knife tube has on both sides of the tunnel an air knife opening blowing a high-pressure hot air toward the compressor, the rear drying room also has an adjustable universal nozzle for blowing a high-pressure air toward a position on the compressor.

7. The compressor cleaner of claim 1, wherein the machine body has an exhaust fan above the cleaning room to draw away moisture during the cleaning process.

8. The compressor cleaner of claim 1, wherein the exit side of the machine body has a sensor for detecting whether a down-going conveyor carries a compressor.
